(19) United States
(12) Patent Application Publication
(10) Pub. No.: US 2013/0110303 A1
(43) Pub. Date: May 2, 2013

(54) Power-Saving Control Apparatus Using Relative Weight

(71) Applicant: Ting-Chia Ou, Taoyuan County (TW)

(72) Inventor: Ting-Chia Ou, Taoyuan County (TW)

(73) Assignee: ATOMIC ENERGY COUNCIL-INSTITUTE OF NUCLEAR ENERGY RESEARCH, Taoyuan County (TW)

(21) Appl. No.: 13/416,239

(22) Filed: Mar. 9, 2012

(30) Foreign Application Priority Data
Oct. 31, 2011 (TW) 100139651

(51) Int. Cl. G06F 1/32

(52) U.S. Cl. 700/295

(57) ABSTRACT

The present invention provides a power-saving apparatus. A relative price is used to reflect a distribution loss of each node. An unloading control process and a distribution network power-off control process are used in phases. The relative price and a distribution network control including node-unloading are used to reduce distribution consumption.

### TECHNICAL FIELD OF THE INVENTION

The present invention relates to a power-saving device; more particularly, relates to using a relative price to reflect a distribution power loss of each node; using an unloading control process and a distribution network power-off control process according to the priority and relative price in each phase to reduce the distribution consumption.

### DESCRIPTION OF THE RELATED ART

A general power meter comprises a meter body, a measuring unit, a transformer, a calculating unit and a warning unit, where the measuring unit is set in the meter body to gather statistics of current; the transformer is set in the meter body and is connected with the measuring unit to transform current data into digital data; the calculating unit is set in the meter body and is connected with the transformer to obtain pricing information from the digital data; and the warning unit is set in the meter body and is connected with the calculating unit. The calculating unit is used to figure out power consumption. When the power consumption exceeds a pricing limit, a signal is send to the warning unit to switch on the warning unit for automatically warning a user the exceeded power consumption. The user may thus try to reduce power consumption.

A general distributed distribution system uses a smart meter for power-saving control and management, where system network allocation efficiency is improved and power loss in wires is reduced for saving power. However, the general smart meter does not automatically and effectively manage power-saving function of load and does not solve the problem of distribution consumption. As a result, the smart meter is not fully functioned for its advantages on calculating and controlling.

Hence, the prior art does not fulfill all users' requests on actual use.

### SUMMARY OF THE INVENTION

The main purpose of the present invention is to use a relative weight to reflect a distribution loss of each node by power price; to use an unloading control process and a distribution network power-off control process in phases; and to use the distribution network control including node-unloading according to higher relative prices and lower consuming priorities to reduce distribution consumption.

To achieve the above purpose, the present invention is a power-saving control apparatus using relative weight, comprising a detection unit; a measuring and calculating unit connected with the detection unit; a configuration unit connected with the detection unit; and a control unit connected with the detection unit, where the measuring and calculating unit gathers statistics of current and related consumption information; the consumption information includes weights of a plurality of nodes in a distribution system; the configuration unit sets a plurality of optimal consumption amounts of the system and a plurality of consuming priorities of the plurality of nodes; the control unit runs an unloading control process and a distribution network power-off control process; the configuration unit sets the plurality of consuming priorities of the plurality of nodes of the system and the plurality of optimal consumption amounts of a first phase and a second phase; and the configuration unit directly obtains a plurality of relative prices of the plurality of nodes by the measuring and calculating unit and obtains a plurality of distribution losses of the plurality of nodes. Accordingly, a novel power-saving control apparatus using relative weight is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the view showing the flow for power-saving;

FIG. 3 is the view showing the control of unloading;

FIG. 4 is the view showing the control of distribution network power-off; and

FIG. 5 is the view showing the state-of use.

### DESCRIPTION OF THE PREFERRED EMBODIMENT(S)

The following description of the preferred embodiment is provided to understand the features and the structures of the present invention.

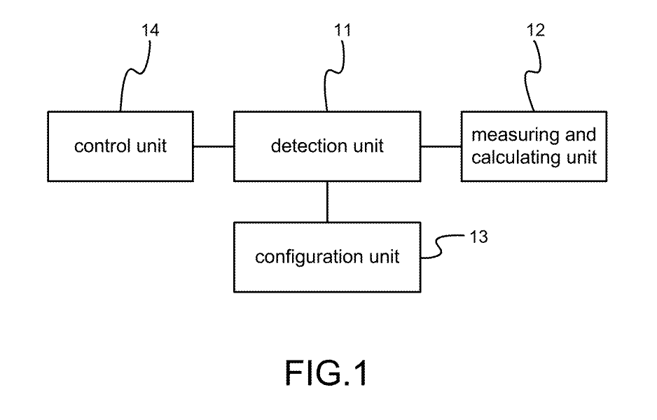

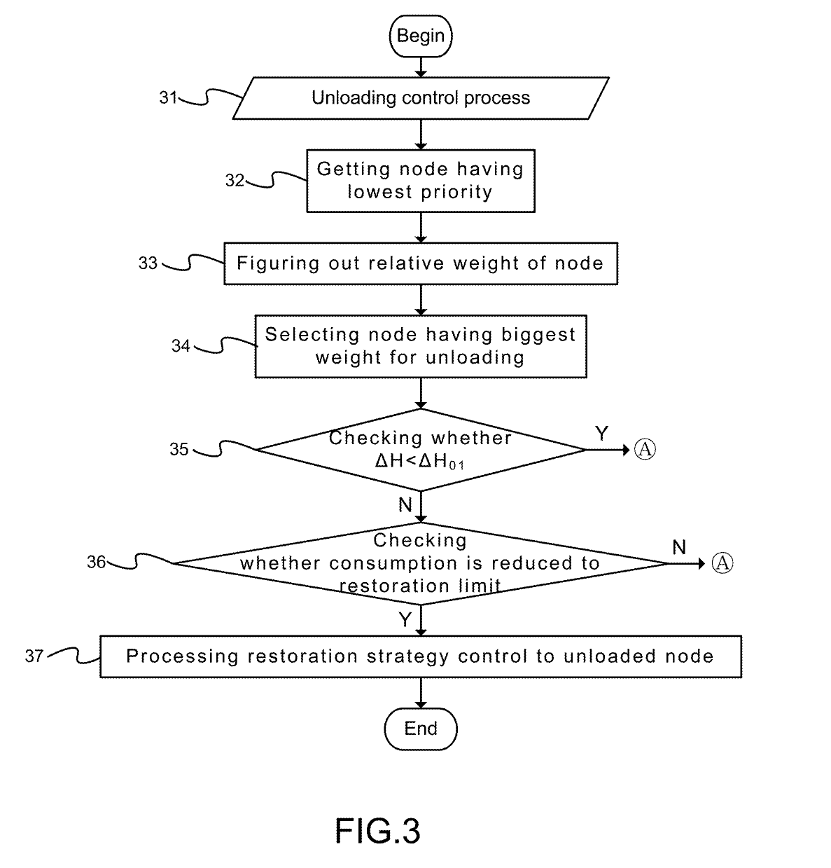

Please refer to FIG. 1 to FIG. 4, which are a structural view showing a preferred embodiment according to the present invention; a view showing the flow for power-saving; and views showing an unloading control process and a distribution network power-off control process. As shown in the figures, the present invention is a power-saving control apparatus using relative weight, comprising a detection unit 11; a measuring and calculating unit 12 connected with the detection unit 11 to gather statistics of current and related consumption information, e.g. weights, of a plurality of nodes of a distribution system; a configuration unit 13 connected with the detection unit 11 to set a plurality of optimal consumption amounts of the system and a plurality of consuming priorities of the plurality of nodes; a control unit 14 connected with the detection unit 11 to run an unloading control process and a distribution network power-off control process. Thus, a novel power-saving control apparatus using relative weight is obtained.

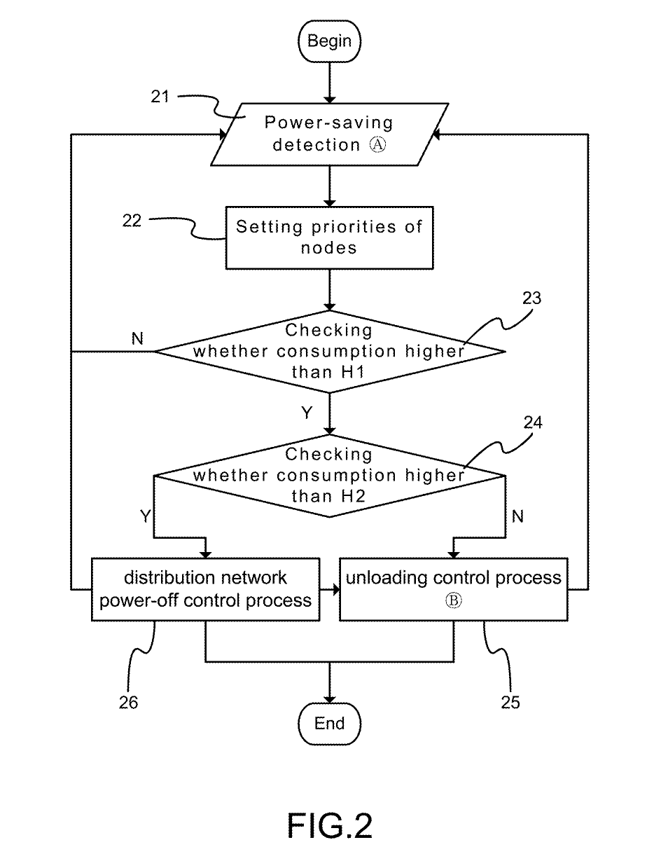

In FIG. 2, detection for power-saving is processed 21 by the detection unit 11 at first. Then, the configuration unit 13 is used to set a consuming priority of each node 22 and to set the plurality of optimal consumption amounts of a first phase and a second phase. The measuring and calculating unit 12 is used to directly translate related data into relative prices for showing a plurality of distribution losses of the plurality of nodes. A relative weight of a node is expressed through the following formula:

$${W}_{i} = \frac{{P}_{i} + \sum {P}_{loss}}{{P}_{i}} \qquad ( 1 )$$

Therein, W is the relative weight; Pᵢ is the consumption amount of the i^{th} node; and Pₗₒₛₛ is the power loss based on considerations like distribution path, etc. Thus, the relative price of a node is figured out by multiplying a common price with the relative weight of the node with the considerations like distribution path, etc. Therein, a higher relative price means a bigger distribution loss and a bigger power consumption amount for a node. Then, the detection unit 11 detects whether the consumption amount is higher than the optimal consumption amount (H1) of the first phase 23. If not, the detection unit 11 keeps detecting; and, if it is found that the consumption amount is higher than H1, it is detected whether the consumption amount is higher than the optimal consumption amount (H2) of the second phase 24. If the consumption amount is only higher than H1, the control unit 14 is used to process the unloading control process 25. If the consumption amount is higher than both H1 and H2, the control unit 14 is used to process the distribution network power-off control process 26.

On running the unloading control process 31, a node having the lowest consuming priority in the first phase is obtained 32. A relative weight of the node having the lowest consuming priority is obtained 33 by the measuring and calculating unit 12. Then, the control unit 14 is used to select the node having the biggest weight to be unloaded 34. The nodes having lower consuming priorities and higher relative prices are processed through the unloading control process to reduce power consumption on distributing and loading. The power consumption mismatch (ΔH) in the distribution system is expressed through the following formula:

ΔH=H^{x}−H1 (2)

Therein, H^{x=n} is the consumption amount of the n nodes before unloading; and, H^{x=n-1} is the consumption amount of the n−1 node after unloading a selected node. For ensuring the consumption amount of the system is lower than H1, it is checked after each unloading control process whether ΔH is lower than an estimated consumption mismatch (ΔH₀₁). ΔH is compared with ΔH₀₁ and extra 0.25 times of ΔH₀₁ is left as a safe spare amount. ΔH₀₁ is figured out through the following formula:

$$Δ {H}_{01} = 1.25 ( {\sum }_{i = 1}^{n} {P}_{i} - H 1 ) \qquad ( 3 )$$

When ΔH is still lower than ΔH₀₁ in the first phase 35, another node is kept on being selected for the unloading control process to reduce the distribution power losses and the load power consumption of the system. After ΔH is not lower than ΔH₀₁, it is checked whether the consumption amount is reduced to a restoration limit 36. If the consumption amount is not reduced to the restoration limit, power-saving detection is processed 21 by the detection unit 11. If the consumption amount is reduced to the restoration limit, the unloaded node is processed through the restoration strategy control 37.

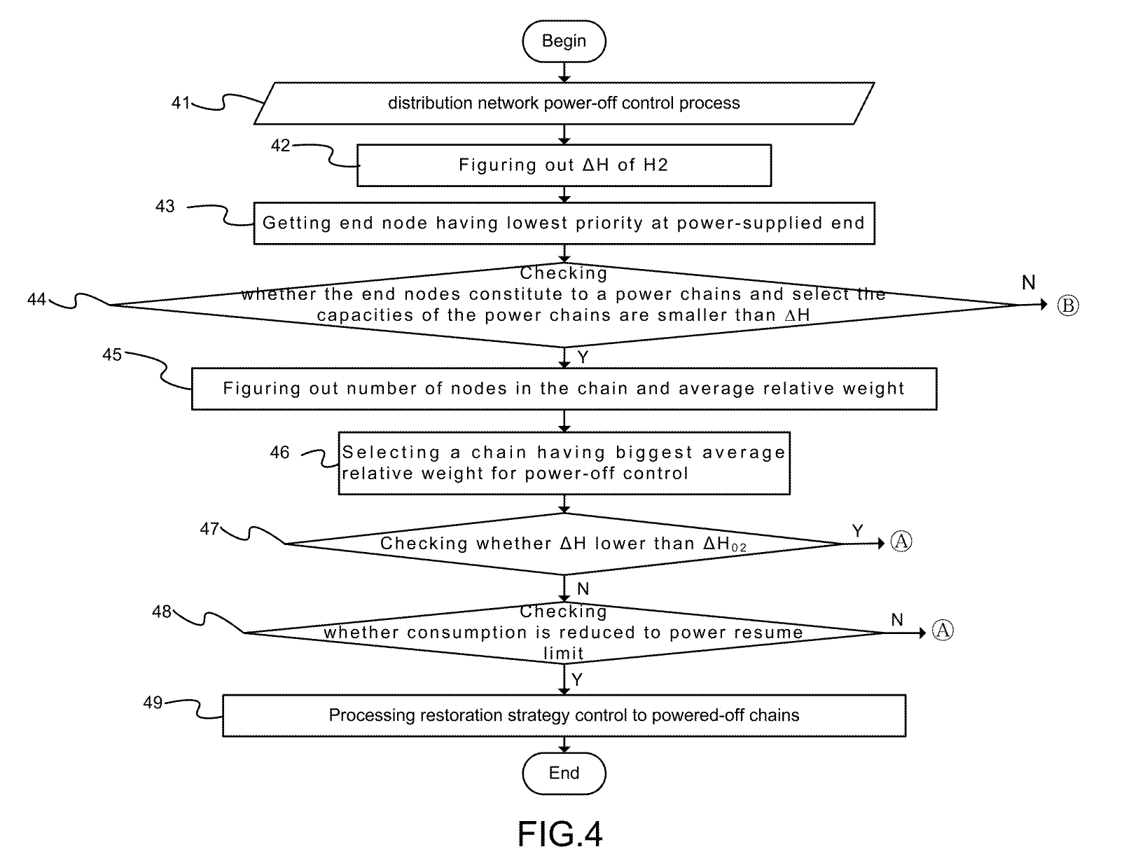

At this moment, if the power consumption is still high or the power-saving control of the first phase fails for making the system consumption amount higher than H2, the control unit 14 is used to run the power-saving control process of the second phase, i.e. the distribution network power-off control process (as shown in FIG. 4). Therein, a power consuming circuit having a lower consuming priority and a higher relative price is processed through distribution network power-off control to greatly reduce the distribution consumption and the load power consumption of the system.

The distribution network power-off control process 41 of the second phase reduces ΔH by distribution network power-off, which is expressed through the following formula:

ΔH=H^{x}−H2 (4)

Therein, H^{x=n} is the total consumption amount before the distribution network power-off control; and H^{x=n-j} is the total consumption amount after the selected power-off chain (j nodes) in distribution network. In FIG. 4, ΔH of the power consumption and H2 are figured out by the measuring and calculating unit 12. An end node having the lowest consuming priority among power-supplied ends is obtained. A mismatch between the total consumption amount before the distribution network power-off control and H2 is used to decide the number of successive power nodes. The measuring and calculating unit 12 is used to figure out whether the end nodes constitute to the power chains and select the capacities of the power chains are smaller than ΔH 44. If not, the unloading control process is run. If yes, the number of successive power nodes and average relative weights of the power chain are obtained 45. The power chain having the biggest average relative weight is obtained to be processed through distribution network power-off 46.

For ensuring the system consumption amount to be lower than H2 of the second phase, it is checked after the distribution network power-off process whether ΔH is lower than an estimated consumption mismatch of the second phase (ΔH₀₂), where extra 0.25 times of ΔH₀₂ is left as a safe spare amount. ΔH₀₂ is figured out through the following formula:

$$Δ {H}_{02} = 1.25 ( {\sum }_{i ∉ j}^{n} {P}_{i} - H 2 ) \qquad ( 5 )$$

Then, when ΔH is still lower than ΔH₀₂ in the second phase 47, another node is kept on to be selected to run the distribution network power-off control process to reduce the distribution power losses and the load power consumption of the system. After ΔH is not lower than ΔH₀₂, it is checked whether the consumption amount is reduced to the restoration limit 48. If the consumption amount is not reduced to the restoration limit, power-saving detection is processed 21 by the detection unit 11. If the consumption amount is reduced to the restoration limit, the power chain is processed through the restoration strategy control 49.

Thus, the present invention is coordinated with relative weights to figure out relative prices of nodes in a system to analyze power-saving control of the system with the smart meter. On consideration of distribution loss on consuming power, an inner analyzing program in the meter uses the relative weights for analysis, where a higher relative price means a bigger distribution loss and consumption at a node. The present invention uses an unloading control process and a distribution network power-off control process for load management, where the meter is used to detect and set consuming priorities of the nodes. If a consumption amount of the system is higher than an optimal power consumption amount, a node having a lower consuming priority and a higher relative price is coordinated to be unloaded. If the power consumption is too high to be above the optimal power consumption amounts, a distribution network power-off control process is run for saving power for the system through the relative price and the distribution network control including node-unloading.

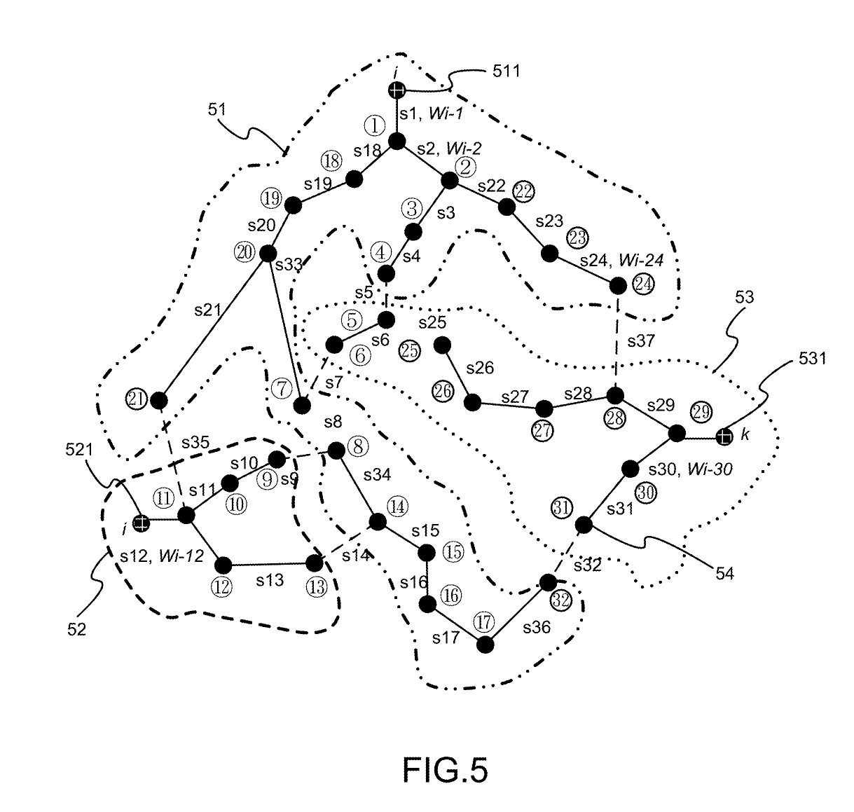

Please refer to FIG. 5, which is a view showing a state-of use. As shown in the figure, a distribution system comprises a first region 51, a second region 52 and a third region 53. Power supplying source ends of the first region 51, the second region 52 and the third region 53 comprises a first power source 511, a second power source 521 and a third power source 531, respectively. Take the third region 53 as an example. Relative prices corresponding to power consumption losses of nodes, e.g. losses in distribution path, are figured out in the present invention. For example, a relative weight and a relative price of a thirty-first node 54 are figured out according to the following formulas:

$$\begin{matrix}relative weight \text{:} {W}_{k \_ 31} = \frac{{P}_{31} + \sum {P}_{loss}}{{P}_{31}} & ( 6 ) \\ relative price \text{:} {P}_{31}^{′} = {P}_{31} + {\sum }_{i = 30 , 31}^{n = 31} {P}_{loss , si}^{( n )} = {W}_{k \_ 31} {P}_{31} & ( 7 )\end{matrix}$$

As shown in the figure, the nodes in the first region 51 of the distribution system are farer to the first power source so that the power losses (e.g. those in distribution path) are bigger and the corresponding relative prices are higher, too. The present invention uses an unloading control process and a distribution network power-off control process for load management and saves power through a distribution network control including node-unloading.

The present invention introduces relative prices and power-saving controls of two phases to enhance load management of a smart meter. A calculating unit uses pricing information to figure out distribution loss with relative weight for pricing. An electricity amount is combined with the distribution loss to be translated into a relative price by the calculating unit. An unloading control process and a distribution network power-off control process are added for coordination. When the consumption amount is over a limit, a signal is outputted to a warning unit to automatically and effectively process load power-saving management for saving power. Thus, a distributed distribution system obtains a more effective power management.

To sum up, the present invention is a power-saving control apparatus using relative weight, where a relative price is used to reflect a distribution loss of each node; an unloading control process and a distribution network power-off control process are used in phases; and the relative price and a distribution network control including node-unloading are used to reduce distribution consumption.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A power-saving control apparatus using relative weight, comprising
a detection unit;
a measuring and calculating unit, said measuring and calculating unit being connected with said detection unit, said measuring and calculating unit gathering statistics of current and related consumption information, said consumption information including weights of a plurality of nodes in a distribution system;
a configuration unit, said configuration unit being connected with said detection unit, said configuration unit setting a plurality of optimal consumption amounts of said system and a plurality of consuming priorities of said plurality of nodes;
a control unit, said control unit being connected with said detection unit, said control unit running an unloading control process and a distribution network power-off control process,
wherein said configuration unit sets said plurality of consuming priorities of said plurality of nodes of said system and said plurality of optimal consumption amounts of a first phase and a second phase; and
wherein said configuration unit directly obtains a plurality of relative prices of said plurality of nodes by said measuring and calculating unit and obtains a plurality of distribution losses of said plurality of nodes.

2. The apparatus according to claim 1,
wherein, when said detection unit finds a consumption amount of said system higher than said optimal consumption amount, said control unit runs said unloading control process and said distribution network power-off control process.

3. The apparatus according to claim 1,
wherein, when said unloading control process is run on finding a consumption amount of said system higher than said optimal consumption amount of said first phase, a node having a lowest consuming priority in said first phase is obtained; a relative weight of said node having said lowest consuming priority is obtained by said measuring and calculating unit; a node having a biggest weight is unloaded; after unloading said a node having said biggest weight, an actual consumption mismatch and an estimated consumption mismatch are compared; it is judged that whether a consumption amount is reduced to a restoration limit; and, if said consumption amount is reduced to said restoration limit, a restoration strategy control is processed to said unloaded node.

4. The apparatus according to claim 1,
wherein, when said distribution network power-off control process is run on finding a consumption amount of said system higher than said optimal consumption amount of said second phase, a power consumption mismatch between a current power consumption and said optimal consumption amount of said first phase is obtained in said second phase; nodes having lowest consuming priorities at power-supplied ends are obtained; it is obtained by said measuring and calculating unit whether said nodes having lowest consuming priorities at power-supplied ends constitute to the power chains and select the capacities of said power chains are smaller than the power mismatch; if not smaller, said unloading control process is run; if smaller, a number of nodes and average relative weights of said power chains are obtained; one of said power chains having a biggest average relative weight is processed through distribution network power-off; after processing distribution network power-off, an actual consumption mismatch and an estimated consumption mismatch are compared; it is judged whether a consumption amount is reduced to a restoration limit; and, if said consumption amount is reduced to said restoration limit, a restoration strategy control is processed to said powered-off chains.
